(19) United States
(12) Patent Application Publication
(10) Pub. No.: US 2026/0106156 A1
(43) Pub. Date: Apr. 16, 2026

(54) ANODE ACTIVE MATERIAL LAYER FOR LITHIUM SECONDARY BATTERY, ANODE INCLUDING THE SAME AND LITHIUM SECONDARY BATTERY INCLUDING THE SAME

(71) Applicant: SK ON CO., LTD., Seoul (KR)

(72) Inventors: Yeong Min JO, Daejeon (KR); In Ha KIM, Daejeon (KR); Mi Ju BAE, Daejeon (KR); In Yong SHIN, Daejeon (KR); Se Mi LEE, Daejeon (KR); Chi Won JEON, Daejeon (KR)

(21) Appl. No.: 19/356,997

(22) Filed: Oct. 13, 2025

(30) Foreign Application Priority Data
Oct. 14, 2024 (KR) 10-2024-0139780

(51) Int. Cl. H01M 4/62; H01M 4/02; H01M 4/04; H01M 4/1393; H01M 4/583; H01M 10/052

(52) U.S. Cl. CPC H01M 4/623; H01M 4/0404; H01M 4/1393; H01M 4/583; H01M 10/052; H01M 2004/027

(57) ABSTRACT

An anode active material layer according to embodiments of the present disclosure includes an anode active material, a first binder including a polymer of an epoxy-based binder or an acrylate-based binder, and a second binder including a binder having a hydroxyl group or a carboxyl group. The content of the first binder is 0.1 wt % to 1 wt % based on the total weight of the anode active material layer. The adhesion strength of the anode active material layer may be improved without degrading the electrical properties of the anode.

### CROSS-REFERENCE TO RELATED APPLICATIONS

This patent application claims the priority and benefits of Korean Patent Application No. 10-2024-0139780 filed on Oct. 14, 2024, the disclosure of which is incorporated herein by reference in its entirety.

### BACKGROUND OF THE INVENTION

### 1. Field of the Invention

Examples of the present application relate to an anode active material layer for a lithium secondary battery, an anode including the same, and a lithium secondary battery including the anode. In addition, examples of the present application relate to a method for manufacturing an anode for a lithium secondary battery.

### 2. Description of the Related Art

Secondary batteries are batteries that can be repeatedly charged and discharged. With the development of information and communication and display industries, they have been widely applied as power sources for portable electronic communication devices such as laptops and mobile phones. In addition, battery packs including secondary batteries have recently been developed and applied as power sources for eco-friendly vehicles, such as electric vehicles.

While there are various types of secondary batteries, lithium secondary batteries are primarily used due to their high operating voltage, fast charging speed, and high power density. Depending on the type of cathode material, lithium secondary batteries may be categorized into NCM (nickel, cobalt, and manganese), NCA (nickel, cobalt, and aluminum), and LFP (lithium, iron, and phosphorus) batteries. Depending on the type of anode material, lithium secondary batteries may be categorized into natural graphite, artificial graphite, graphite-based, and metal-based batteries.

Anode materials commonly used in lithium secondary batteries include graphite having stability and silicon. Graphite is characterized by high stability, while silicon is characterized by high energy density.

Recently, as the application range of lithium secondary batteries expands, the need for high energy density, high stability, and fast charging is increasing. For example, batteries used in electric vehicles require higher capacities than conventional lithium secondary batteries. To meet the above-described requirements, attempts have been made to use anode materials in combination. However, the high volume expansion rate of silicon is difficult to control. Consequently, cracks may occur in the active material due to reactions with lithium during charging and discharging, leading to a rapid decline in the cycle life and fast charging characteristics of the lithium secondary batteries.

### SUMMARY OF THE INVENTION

An object of the present disclosure is to provide an anode active material layer for a lithium secondary battery with improved mechanical stability and electrical properties.

Another object of the present disclosure is to provide an anode for a lithium secondary battery with improved mechanical stability and electrical properties.

Still another object of the present disclosure is to provide a lithium secondary battery with improved mechanical stability and electrical properties.

Yet another object of the present disclosure is to provide a method for manufacturing an anode for a lithium secondary battery with improved mechanical stability and electrical properties.

An anode active material layer for a lithium secondary battery according to exemplary embodiments of the present disclosure includes: an anode active material; a first binder including a polymer of an epoxy-based binder or an acrylate-based binder, and a second binder including a binder having a hydroxyl group or a carboxyl group. The content of the first binder is 0.1% by weight to 1% by weight based on the total weight of the anode active material layer.

According to exemplary embodiments, the content of the second binder may be 0.3% by weight to 1.7% by weight based on the total weight of the anode active material layer.

According to exemplary embodiments, the sum of the contents of the first and second binders may be 1.0% by weight to 2.0% by weight based on the total weight of the anode active material layer.

According to exemplary embodiments, the anode active material layer may further include a third binder including a fluorine-based binder or a rubber-based binder.

According to exemplary embodiments, the epoxy-based binder may include epoxy groups at both ends and ethylene glycol repeating units.

According to exemplary embodiments, the acrylate-based binder may include acrylate groups at both ends and ethylene glycol repeating units.

According to exemplary embodiments, the second binder may include a cellulose-based binder.

According to exemplary embodiments, the adhesion strength may be 0.05 kN/m to 0.30 kN/m.

An anode for a lithium secondary battery according to exemplary embodiments of the present disclosure includes: an anode current collector, and the anode active material layer disposed on at least one surface of the anode current collector.

A lithium secondary battery according to exemplary embodiments of the present disclosure includes: the anode for a lithium secondary battery; and a cathode disposed opposite to the anode for the lithium secondary battery.

In a method for manufacturing an anode for a lithium secondary battery according to exemplary embodiments of the present disclosure, an anode slurry including an anode active material, a first preliminary binder including an epoxy-based binder or an acrylate-based binder, and a second binder including a hydroxyl group or a carboxyl group is prepared. The anode slurry is applied to an anode current collector to form a preliminary anode active material layer. The preliminary anode active material layer is irradiated with an electron beam to form an anode active material layer.

According to exemplary embodiments, in the step of irradiating the preliminary anode active material layer with an electron beam to form the anode active material layer, a first binder including a polymer of the epoxy-based binder or the acrylate-based binder may be formed from the first preliminary binder.

According to exemplary embodiments, the content of the first binder may be 0.1% by weight to 1% by weight based on the total weight of the anode active material layer.

According to exemplary embodiments, the electron beam may be irradiated under a voltage condition of 0.05 MeV to 10 MeV.

According to exemplary embodiments, the dose of the electron beam may be 10 kGy to 300 kGy.

The anode active material layer for a lithium secondary battery according to exemplary embodiments of the present disclosure may include a first binder including a polymer of an epoxy-based binder or an acrylate-based binder. The first binder may enhance the adhesion strength between anode active materials.

According to exemplary embodiments, the content of the first binder may be 0.1% by weight (“wt %”) to 1 wt % based on the total weight of the anode active material layer. By controlling the content of the first binder, the adhesion strength may be enhanced without degrading the electrical characteristics of the anode.

In the method for manufacturing an anode for a lithium secondary battery according to exemplary embodiments, a preliminary anode active material layer formed from an anode slurry including an anode active material, a first preliminary binder including an epoxy-based binder or an acrylate-based binder, and a second binder including a hydroxyl group or a carboxyl group may be irradiated with an electron beam. Accordingly, an anode for a lithium secondary battery including an anode active material layer with improved adhesion strength may be provided.

The anode active material layer, the anode, and the lithium secondary battery of the present disclosure may be widely applied in green technology fields, such as electric vehicles, battery charging stations, as well as solar power generation, wind power generation, and the like, which use the batteries. In addition, the anode active material layer, the anode, and the lithium secondary battery of the present disclosure may be used in eco-friendly electric vehicles, hybrid vehicles, and the like, which are aimed at mitigating climate change by reducing air pollution and greenhouse gas emissions.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic cross-sectional view illustrating an anode for a lithium secondary battery according to exemplary embodiments;

FIGS. 2 and 3 are schematic plan and cross-sectional views illustrating a lithium secondary battery according to exemplary embodiments; and

FIG. 4 is a schematic flowchart illustrating a method for manufacturing an anode for a lithium secondary battery according to exemplary embodiments.

### DETAILED DESCRIPTION OF THE INVENTION

According to embodiments of the present disclosure, an anode active material layer for a lithium secondary battery is provided, which includes an anode active material, a first binder including an epoxy-based binder or an acrylate-based binder, and a second binder including a binder having a hydroxyl group or a carboxyl group. In addition, an anode including the anode active material layer is provided. Further, a lithium secondary battery including the anode is provided.

According to embodiments of the present disclosure, a method for manufacturing an anode for a lithium secondary battery is provided, which uses an anode active material, a first preliminary binder including an epoxy compound or an acrylate compound, and a second binder including a hydroxyl group or a carboxyl group.

As used herein, the term “carbon-based active material” may refer to an active material that contains carbon but does not contain silicon.

As used herein, the term “silicon-based active material” may refer to an active material that contains silicon.

The present disclosure will be described in more detail below with reference to the drawings and embodiments. However, the following drawings and embodiments, attached and described herein, illustrate exemplary embodiments of the present disclosure and, together with the above-described disclosure, serve to further enhance the understanding of the technical concepts of the present disclosure. Therefore, the present disclosure should not be construed as being limited to the details described in the drawings and embodiments.

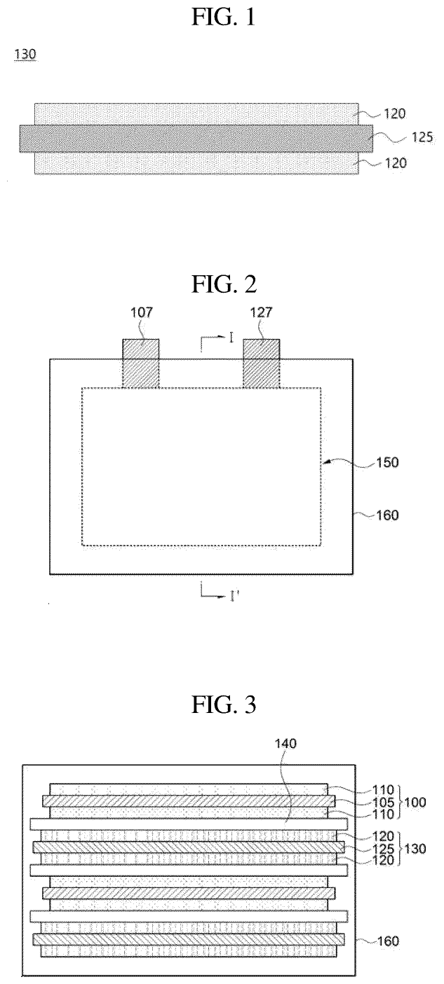

FIG. 1 is a schematic cross-sectional view illustrating an anode for a lithium secondary battery according to exemplary embodiments.

Referring to FIG. 1, an anode 130 for a lithium secondary battery (hereinafter, abbreviated as “anode”) may include an anode current collector 125 and an anode active material layer 120 for a lithium secondary battery (hereinafter, abbreviated as “anode active material layer”) formed on at least one surface of the anode current collector 125.

According to exemplary embodiments, the anode active material layer 120 may be formed on both surfaces (e.g., the upper and lower surfaces) of the anode current collector 125. For example, the anode active material layer 120 may be in direct contact with the surface of the anode current collector 125.

For example, the anode current collector 125 may include a metal that has high conductivity, high adhesion to the anode slurry, and does not cause chemical changes within the operating voltage range of the secondary battery. Specifically, the anode current collector 125 may include copper, stainless steel, aluminum, nickel, titanium, or an alloy thereof. Alternatively, the anode current collector 125 may include copper or stainless steel having a surface treated with carbon, nickel, titanium, or silver.

The anode current collector 125 may have a thickness of 3 μm to 500 μm, and may include a structure for enhancing adhesion to the anode active material on the current collector surface.

The anode active material layer 120 may include an anode mixture including the anode active material. For example, the anode mixture may be dispersed in a solvent to prepare an anode slurry. The anode slurry may be coated on the anode current collector 125, followed by drying and roll-pressing to form the anode active material layer 120.

The solvent may include water, pure water, deionized water, distilled water, ethanol, isopropanol, methanol, acetone, n-propanol, t-butanol, and the like.

The anode mixture may include the anode active material, a binder, a conductive material, and a silane coupling agent. In some embodiments, the total weight of the anode mixture may be substantially the same as the total weight of the anode active material layer 120. In some embodiments, the content of the components based on the total weight of the anode mixture may be substantially the same as the content of the components based on the total weight of the anode active material layer 120.

The anode active material layer 120 includes: an anode active material; a first binder including a polymer of an epoxy-based binder or an acrylate-based binder, and a second binder including a binder having a hydroxyl group or a carboxyl group.

As the anode active material, a material capable of adsorbing and desorbing lithium ions may be used. For example, as the anode active material, carbon-based materials such as crystalline carbon, amorphous carbon, carbon composites, or carbon fibers, etc.; lithium metal; a lithium alloy; a silicon (Si)-containing material or a tin (Sn)-containing material may be used.

Examples of the amorphous carbon may include hard carbon, soft carbon, coke, mesocarbon microbead (MCMB), mesophase pitch-based carbon fiber (MPCF) or the like.

Examples of the crystalline carbon may include graphite-based carbon such as natural graphite, artificial graphite, graphitized coke, graphitized MCMB, graphitized MPCF or the like.

According to exemplary embodiments, the graphite-based active material may include artificial graphite. According to embodiments of the present disclosure, the content of the artificial graphite based on the total weight of the anode active material layer 120 may be 50 wt % or more.

In some embodiments, the content of the artificial graphite based on the total weight of the anode active material layer 120 may be greater than 50 wt %, 60 wt % or more, 65 wt % or more, 70 wt % or more, 75 wt % or more, or 80 wt % or more.

Artificial graphite has relatively stable capacity characteristics and may provide improved chemical stability during repeated charging and discharging. By using an excessive amount of artificial graphite in the anode mixture, stable capacity characteristics may be provided from the anode 130, and excessive expansion/contraction of the anode 130 or the electrode assembly during repeated charging and discharging may be prevented.

In some embodiments, the anode active material may further include natural graphite. Adding natural graphite may further increase the capacity of the secondary battery. According to exemplary embodiments, the content (wt %) of natural graphite may be less than that of artificial graphite. In some embodiments, the content of natural graphite based on the total weight of the anode active material layer 120 may be 40 wt % or less.

In some embodiments, the content of the artificial graphite based on the total weight of the anode active material layer 120 may be 90 wt % or less. For example, the content of the artificial graphite may be 50 wt % to 90 wt %, or more than 50 wt % and less than or equal to 90 wt %. In one embodiment, the content of the artificial graphite may be 60 wt % to 85 wt %, or 65 wt % to 80 wt %.

In some embodiments, the content of the natural graphite based on the total weight of the anode active material layer 120 may be 9 wt % to 40 wt %, 10 wt % to 30 wt %, or 15 wt % to 30 wt %.

In some embodiments, the anode active material may further include a silicon-based active material (e.g., a silicon-containing active material) in an amount within a range that does not impair the capacity characteristics and stability of the artificial graphite. The silicon-based active material may include Si, SiOₓ (0<x<2), a silicon-carbon composite (Si/C), a silicon oxide (silicate)-carbon composite (SiO/C), silicon metal (Si-Metal), etc. In some embodiments, the silicon-based active material may include a lithium-silicate compound, and may include a lithium-silicate compound doped with elements such as magnesium or aluminum.

In some embodiments, the silicon-based active material may include the silicon-carbon composite. The silicon-carbon composite may include a carbon core and a silicon coating formed on the carbon core.

For example, the carbon core may have a porous structure, and the silicon coating may be formed on the porous carbon core through a deposition process such as chemical vapor deposition (CVD).

In one embodiment, the content (wt %) of the silicon-based active material may be less than that of natural graphite. For example, the content of the silicon-based active material may be 10 wt % or less, 8 wt % or less, or 5 wt % or less.

In some embodiments, the content of the artificial graphite to the content of the natural graphite may be 2 to 5.

In some embodiments, the content of the artificial graphite to the content of the natural graphite may be 2 or more, 2.1 or more, 2.2 or more, 2.3 or more, or 2.4 or more. In some embodiments, the content of the artificial graphite to the content of natural graphite may be 5 or less, 4.5 or less, 4.0 or less, 3.8 or less, 3.6 or less, 3.5 or less, 3.4 or less, 3.3 or less, 3.2 or less, 3.1 or less, or 3.0 or less.

When artificial graphite and natural graphite are included in the content ratios, the capacity characteristics and charge and discharge characteristics of the lithium secondary battery may be improved simultaneously.

The first binder includes a polymer of an epoxy-based binder or a polymer of an acrylate-based binder.

According to exemplary embodiments, the epoxy-based binder may include an epoxy group at one or both ends.

For example, the epoxy-based binder may include ethylene glycol diglycidyl ether, poly(ethylene glycol) diglycidyl ether, glycerol diglycidyl ether, bisphenol-A diglycidyl ether, neopentyl glycol diglycidyl ether, 1,4 cyclohexanedimethanol diglycidyl ether, 1,4 butanediol diglycidyl ether, and the like.

According to exemplary embodiments, the acrylate-based binder may include an acrylate group at one or both ends.

For example, the acrylate-based binder may include ethyl acrylate, n-butyl acrylate, isobutyl acrylate, 2-ethylhexyl acrylate, isobornyl acrylate, diethylene glycol diacrylate, poly(ethylene glycol) diacrylate, polymethyl acrylate, 1,6-hexanediol diacrylate, 1,4-butanediol diacrylate, and the like.

In some embodiments, the epoxy-based binder may include a polymer including epoxy groups at both ends.

In some embodiments, the acrylate-based binder may include a polymer including acrylate groups at both ends.

The polymer may include, for example, poly(ethylene glycol), poly(propylene glycol), polytetramethylene glycol, polyglycerol, and the like.

In some embodiments, the polymer may include ethylene glycol repeating units.

In some embodiments, the polymer may have a number-average molecular weight (Mn) of 100 or more, 150 or more, 200 or more, 250 or more, or 300 or more. In some embodiments, the number-average molecular weight (Mn) of the polymer may be 3,000 or less, 2,500 or less, 2,000 or less, 1,500 or less, 1,200 or less, or 1,000 or less.

The polymer having the above number-average molecular weight may be uniformly mixed with other binders included in the anode active material layer 120, thereby improving the adhesion strength of the anode active material layer 120.

According to exemplary embodiments, the content of the first binder may be 0.1 wt % to 1 wt % based on the total weight of the anode active material layer 120.

In some embodiments, the content of the first binder may be 0.10 wt % or more, 0.12 wt % or more, 0.14 wt % or more, 0.15 wt % or more, 0.16 wt % or more, 0.17 wt % or more, 0.18 wt % or more, 0.19 wt % or more, or 0.20 wt % or more, based on the total weight of the anode active material layer 120.

In some embodiments, the content of the first binder may be 1.00 wt % or less, 0.98 wt % or less, 0.96 wt % or less, 0.95 wt % or less, 0.94 wt % or less, 0.93 wt % or less, 0.92 wt % or less, 0.91 wt % or less, or 0.90 wt % or less, based on the total weight of the anode active material layer 120.

As the content of the first binder is within the above range, the adhesion strength of the anode active material layer 120 may be improved without increasing the resistance of the anode.

For example, if the content of the first binder is less than the above range, the first binder may not be uniformly included in the anode active material layer, and consequently, the bonding between binders and the bonding between anode active materials may be weakened. Therefore, cracks may occur due to the volume expansion of the anode active material, thereby degrading the cycle life characteristics of the lithium secondary battery.

For example, if the content of the first binder exceeds the above range, a composite structure formed by the combination of the first binder and the second binder may partially block the lithium ion migration path. Consequently, the resistance of the anode may increase, thereby degrading the electrical characteristics of the lithium secondary battery.

For example, the first binder may be formed by crosslinking using an electron beam. For example, the electron beam may promote bonding between the epoxy-based binders or the acrylate-based binders, thereby forming the first binder. For example, the electron beam may partially bond the epoxy-based binder or the acrylate-based binder with the second binder.

According to exemplary embodiments, the second binder may include a binder including a hydroxyl group or a carboxyl group.

For example, the binder including a hydroxyl group or a carboxyl group may include a cellulose-based binder such as carboxymethyl cellulose (CMC), starch, or hydroxypropyl cellulose; a polyacrylic acid-based binder, or the like.

According to exemplary embodiments, the second binder may include a cellulose-based binder.

According to exemplary embodiments, the content of the second binder may be 0.3 wt % to 1.7 wt % based on the total weight of the anode active material layer 120.

In some embodiments, the content of the second binder may be 0.3 wt % or more, 0.35 wt % or more, 0.40 wt % or more, 0.45 wt % or more, 0.50 wt % or more, 0.55 wt % or more, 0.57 wt % or more, 0.58 wt % or more, 0.59 wt % or more, or 0.60 wt % or more, based on the total weight of the anode active material layer 120.

In some embodiments, the content of the second binder may be 1.70 wt % or less, 1.65 wt % or less, 1.60 wt % or less, 1.55 wt % or less, 1.50 wt % or less, 1.45 wt % or less, 1.40 wt % or less, 1.35 wt % or less, 1.33 wt % or less, 1.32 wt % or less, 1.31 wt % or less, or 1.30 wt % or less, based on the total weight of the anode active material layer 120.

The second binder included in the anode active material layer 120 within the above content range may suppress precipitation of the anode active material in the slurry, thereby suppressing an increase in resistance due to agglomeration of the anode active material.

According to exemplary embodiments, the sum of the contents of the first and second binders may be 1.0 wt % to 2.0 wt % based on the total weight of the anode active material layer 120.

In some embodiments, the sum of the contents of the first and second binders may be 1.0 wt % or more, 1.05 wt % or more, 1.10 wt % or more, 1.15 wt % or more, 1.17 wt % or more, 1.18 wt % or more, 1.19 wt % or more, or 1.20 wt % or more, based on the total weight of the anode active material layer 120.

In some embodiments, the sum of the contents of the first and second binders may be 2.0 wt % or less, 1.95 wt % or less, 1.90 wt % or less, 1.85 wt % or less, 1.83 wt % or less, 1.82 wt % or less, 1.81 wt % or less, or 1.80 wt % or less, based on the total weight of the anode active material layer 120.

In the anode active material layer 120, where the sum of the contents of the first and second binders is within the above range, an increase in resistance due to the binder may be suppressed.

According to exemplary embodiments, the anode active material layer 120 may further include a third binder including a fluorine-based binder or a rubber-based binder.

For example, the fluorine-based binder may include vinylidene fluoride, polyvinylidene fluoride (PVDF), tetrafluoroethylene, polytetrafluoroethylene (PTFE), hexafluoropropylene (HFP), vinylidene fluoride-co-hexafluoropropylene (PVDF-co-HFP), polychlorotrifluoroethylene, and the like.

For example, the rubber-based binder may include nitrile-butadiene rubber (NBR), hydrogenated nitrile-butadiene rubber (HNBR), styrene-butadiene rubber (SBR), hydrogenated styrene-butadiene rubber (HSBR), styrene-isoprene rubber, and the like.

According to exemplary embodiments, the content of the third binder may be 1 wt % to 3 wt % based on the total weight of the anode active material layer 120.

In some embodiments, the content of the third binder may be 1.0 wt % or more, 1.1 wt % or more, 1.2 wt % or more, 1.3 wt % or more, 1.4 wt % or more, 1.5 wt % or more, 1.55 wt % or more, 1.57 wt % or more, 1.58 wt % or more, 1.59 wt % or more, or 1.60 wt % or more, based on the total weight of the anode active material layer 120. In some embodiments, the content of the third binder may be 3.0 wt % or less, 2.9 wt % or less, 2.8 wt % or less, 2.7 wt % or less, 2.6 wt % or less, 2.5 wt % or less, 2.4 wt % or less, 2.35 wt % or less, 2.33 wt % or less, 2.32 wt % or less, 2.31 wt % or less, or 2.30 wt % or less, based on the total weight of the anode active material layer 120.

The anode active material layer 120 including the third binder within the above range may suppress volume expansion of the active material that occurs during charging and discharging, thereby improving the cycle life characteristics of the lithium secondary battery.

In some embodiments, the anode active material layer 120 may further include a silane coupling agent. The silane coupling agent may strengthen the bonding between binders and protect the surface of the anode current collector 125.

The silane coupling agent may include vinylsilane coupling agents such as vinyltrichlorosilane, vinyltris(2-methoxyethoxy)silane, vinyltriethoxysilane, and vinyltrimethoxysilane; (meth)acrylic silane coupling agents such as 3-methacryloxypropyltrimethoxysilane and 3-methacryloxypropyltriethoxysilane; epoxy silane coupling agents such as 2-(3,4 epoxycyclohexyl)-ethyltrimethoxysilane, 3-glycidyloxypropyltrimethoxysilane, 3-glycidyloxypropylmethyldiethoxysilane, and gamma-glycidoxypropyltrimethoxy silane; amino silane coupling agents such as N-2-(aminoethyl)-3-aminopropylmethyldimethoxysilane, N-2-(aminoethyl)-3-aminopropyltrimethoxysilane, N-phenyl-3-aminopropyltrimethoxysilane, 3-aminopropylmethyldiethoxysilane, 3-aminopropyltrimethoxysilane, and 3-aminopropyltriethoxysilane; alkoxy silane coupling agents such as 3-chloropropyltrimethoxysilane and 3-chloropropyltriethoxysilane; 3-mercaptopropyltrimethoxysilane and 3-mercaptopropyltriethoxysilane, and the like. These may be used alone or in combination of two or more thereof.

In some embodiments, the silane coupling agent may include a vinylsilane coupling agent and/or an epoxy silane coupling agent.

In some embodiments, the content of the silane coupling agent may be 0.01 wt % or more, 0.02 wt % or more, 0.03 wt % or more, 0.04 wt % or more, or 0.05 wt % or more, based on the total weight of the anode active material layer 120. In some embodiments, the content of the silane coupling agent may be 0.8 wt % or less, 0.7 wt % or less, 0.6 wt % or less, 0.5 wt % or less, or 0.4 wt % or less, based on the total weight of the anode active material layer 120.

According to exemplary embodiments, the anode active material layer 120 may include a conductive material.

The conductive material may be included to promote electron migration between the active material particles. For example, the conductive material may include carbon-based conductive materials such as graphite, carbon black, graphene, or carbon nanotubes and/or metal-based conductive materials, including perovskite materials, such as tin, tin oxide, titanium oxide, LaSrCoO₃, and LaSrMnO₃, etc.

According to exemplary embodiments, the content of the conductive material may be 0.1 wt % to 3 wt % based on the total weight of the anode active material layer 120. However, the content of the conductive material may not be limited.

The anode active material layer 120 may have an adhesion strength of 0.05 kN/m to 0.30 kN/m. The adhesion strength may represent a property of the anode active material layer 120 measured by a Surface and Interfacial Cutting Analysis System (SAICAS).

The adhesion strength may be measured after inserting a measuring blade into the anode active material layer 120 to a predetermined depth in the constant-speed measurement mode of SAICAS.

The adhesion strength may represent the cohesive strength of the anode active material layer 120. For example, it may represent the adhesion strength between anode active materials included in the anode active material layer 120.

The adhesion strength may be distinguished from the adhesive strength between the anode active material layer 120 and the anode current collector 125. For example, the adhesive strength between the anode active material layer 120 and the anode current collector 125 may be measured using a universal testing machine, or the like.

For example, Borazon may include a cubic form of boron nitride (BN). For example, Borazon may include a crystal formed by sintering boron and nitrogen at high temperature and high pressure, and may represent a trade name of a material known in the art.

In some embodiments, the adhesion strength may be measured by inserting a Borazon blade having a thickness of 1.0 mm into the surface of the anode active material layer (the surface opposite to the surface of the anode current collector) to a depth of 15 μm under conditions of a rake angle of 20° and a clearance angle of 10°, and then moving the blade horizontally at a speed of 5 μm/sec and vertically at a speed of 0.5 μm/sec.

In some embodiments, the adhesion strength may be 0.07 kN/m or more, 0.08 kN/m or more, 0.09 kN/m or more, 0.10 kN/m or more, 0.11 kN/m or more, 0.12 kN/m or more, 0.13 kN/m or more, 0.14 kN/m or more, or 0.15 kN/m or more. In some embodiments, the adhesion strength may be 0.28 kN/m or less, 0.27 kN/m or less, 0.26 kN/m or less, 0.25 kN/m or less, or 0.24 kN/m or less.

Within the above range, sufficient peeling strength and mechanical stability may be secured without excessively increasing the resistance of the anode 130.

In some embodiments, the resistance (interface resistance) measured at the surface of the anode active material layer 120 may be 0.1 Ω·cm² or less. In one embodiment, the resistance of the anode active material layer 120 may be less than 0.1 Ω·cm², 0.01 Ω·cm² to 0.1 Ω·cm², 0.02 Ω·cm² to 0.09 Ω·cm², or 0.03 Ω·cm² to 0.08 Ω·cm².

The anode active material layer 120 may have a thickness of 10 μm to 400 μm, 20 μm to 300 μm, 40 μm to 200 μm, 50 μm to 150 μm, or 50 μm to 100 μm.

FIGS. 2 and 3 are schematic plan and cross-sectional views illustrating a lithium secondary battery according to exemplary embodiments, respectively. For example, FIG. 3 is a cross-sectional view taken along line I-I′ of FIG. 2 in the thickness direction of the battery.

Referring to FIGS. 2 and 3, the lithium secondary battery may include an electrode assembly including a cathode 100 and the anode 130. In some embodiments, the electrode assembly may further include a separation membrane (separator) 140 interposed between the cathode and the anode. The electrode assembly may be accommodated in a case 160 together with an electrolyte to be impregnated.

The cathode current collector 105 may include stainless steel, nickel, aluminum, titanium, or an alloy thereof. The cathode current collector may also include aluminum or stainless steel having a surface treated with carbon, nickel, titanium or silver.

For example, the cathode active material may include a compound capable of reversibly intercalating and deintercalating lithium ions.

According to exemplary embodiments, the cathode active material may include a lithium-nickel metal oxide. The lithium-nickel metal oxide may further include at least one of cobalt (Co), manganese (Mn) and aluminum (Al).

In some embodiments, the cathode active material or the lithium-nickel metal oxide may include a layered structure or a crystal structure represented by Formula 1 below.

LiₓNi_{1-y}M_{y}O_{2+z} [Formula 1]

In Formula 1, x, y and z may satisfy 0.9≤x≤1.2, 0≤y≤0.7, and −0.1≤z≤0.1. M may represent one or more elements selected from Na, Mg, Ca, Y, Ti, Hf, V, Nb, Ta, Cr, Mo, W, Mn, Co, Fe, Cu, Ag Zn, B, Al, Ga, Sn or Zr.

The chemical structure represented by Formula 1 indicates a bonding relationship between elements included in the layered structure or the crystal structure of the cathode active material, and does not exclude other additional elements. For example, M includes Co and/or Mn, and Co and/or Mn may be provided as main active elements of the cathode active material together with Ni. Here, it should be understood that Formula 1 is provided to express the bonding relationship between the main active elements, and is a formula encompassing the introduction and substitution of additional elements.

In one embodiment, the cathode active material may further include auxiliary elements which are added to the main active elements, in order to enhance chemical stability thereof or the layered structure/crystal structure. The auxiliary element may be incorporated into the layered structure/crystal structure together with the main active elements to form bonds, and it should be understood that this case is also included within the chemical structure range represented by Formula 1.

The auxiliary element may include, for example, at least one selected from the group consisting of Na, Mg Ca, Y, Ti, Hf, V, Nb, Ta, Cr, Mo, W, Fe, Cu, Ag Zn, B, Al, Ga, C, Si, Sn, Sr, Ba, Ra, P and Zr. The auxiliary element may also act, for example, as an auxiliary active element which contributes to the capacity/output activity of the cathode active material together with Co or Mn, such as Al.

For example, a cathode slurry may be prepared by mixing the cathode active material in a solvent. The cathode slurry may be coated on a cathode current collector 105, followed by drying and roll-pressing to prepare a cathode active material layer 110. The cathode slurry may further include a binder, and optionally may further include a conductive material, a thickener and the like.

Non-limiting examples of solvents used in the preparation of the cathode slurry may include N-methyl-2-pyrrolidone (NMP), dimethylformamide, dimethylacetamide, N,N-dimethylaminopropylamine, ethylene oxide, tetrahydrofuran and the like.

The binder may include polyvinylidene fluoride (PVDF), poly(vinylidene fluoride-co-hexafluoropropylene), polyacrylonitrile, polymethylmethacrylate, acrylonitrile butadiene rubber (NBR), poly(butadiene) rubber (BR), styrene-butadiene rubber (SBR) and the like. In one embodiment, a PVDF-based binder may be used as the cathode binder.

The conductive material may be added to the cathode slurry layer to enhance the conductivity thereof and/or the mobility of lithium ions or electrons. For example, the conductive material may include carbon-based conductive materials such as graphite, carbon black, acetylene black, Ketjen black, graphene, carbon nanotubes, vapor-grown carbon fibers (VGCFs), and carbon fibers; and/or metal-based conductive materials such as tin, tin oxide, and titanium oxide; and perovskite materials such as LaSrCoO₃, and LaSrMnO₃.

The separator 140 may be interposed between the cathode 100 and the anode 130. The separator may prevent an electrical short-circuit between the cathode and the anode, and maintain the flow of ions.

The separator 140 may include a porous polymer film or a porous non-woven fabric. For example, the porous polymer film may include an ethylene homopolymer, a propylene homopolymer, an ethylene/butene copolymer, an ethylene/hexene copolymer, an ethylene/methacrylate copolymer, etc. The porous non-woven fabric may include glass fibers having a high melting point, polyethylene terephthalate fibers and the like. The separator 140 may also include a ceramic material. For example, inorganic particles may be coated on the polymer film or dispersed in the polymer film to improve heat resistance.

According to exemplary embodiments, an electrode cell is defined by the cathode 100, the anode 130, and the separator 140, and a plurality of electrode cells may be stacked to form, for example, an electrode assembly 150. The electrode assembly 150 may be a winding-type, a stacking-type, a z-folding-type, or a stacked-folding type.

The electrode assembly 150 may be accommodated in the case 160 together with an electrolyte to define a secondary battery. According to exemplary embodiments, a non-aqueous electrolyte may be used as the electrolyte.

The non-aqueous electrolyte may include a lithium salt of an electrolyte and an organic solvent. The lithium salt is represented by, for example, Li⁺X⁻; and as an anion (X⁻) of the lithium salt, F⁻, Cl⁻, Br⁻, I⁻, NO₃⁻, N(CN)₂⁻; BF₄⁻, ClO₄⁻, PF₆⁻, (CF₃)₂PF₄⁻, (CF₃)₃PF₃⁻, (CF₃)PF₂⁻, (CF₃)₅PF⁻, (CF₃)₆P⁻, CF₃SO₃⁻, CF₃CF₂SO₃⁻, (CF₃SO₂)₂N⁻; (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethyl sulfuroxide, acetonitrile, dimethoxyethane, diethoxyethane, vinylene carbonate, sulfolane, gamma-butyrolactone, propylene sulfite and tetrahydrofuran, etc. may be used. These may be used alone or in combination of two or more thereof.

In some embodiments, a solid electrolyte may be used in place of the above-described non-aqueous electrolyte. In this case, the lithium secondary battery may be manufactured in the form of an all-solid-state battery. In addition, a solid electrolyte layer may be disposed between the cathode and the anode in place of the above-described separator.

The solid electrolyte may include a sulfide-based electrolyte. As a non-limiting example, the sulfide-based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, Z is Ge, Zn or Ga), Li₂S—GeS₂, Li₂S—SiS₂—Li₃PO₄, Li₂S—SiS₂-LiₚMO_{q} (p and q are positive numbers, M is P, Si, Ge, B, Al, Ga or In), Li₇-xPS₆-xClₓ (0≤x≤2), Li₇-xPS₆-xBrₓ (0≤x≤2), Li₇-xPS₆-xIₓ (0≤x≤2), etc. These may be used alone or in combination of two or more thereof.

In one embodiment, the solid electrolyte may include an oxide-based amorphous solid electrolyte, such as, for example, Li₂O—B₂O₃—P₂O₅, Li₂O—SiO₂, Li₂O—B₂O₃, Li₂O—B₂O₃—ZnO, etc.

As illustrated in FIG. 3, electrode tabs (cathode tabs and anode tabs) may protrude from the cathode current collector 105 and the anode current collector 125, each belonging to a respective electrode cell, and may extend to one side of the case 160. The electrode tabs may be welded together with the one side of the case 160 and connected to electrode leads (a cathode lead 107 and an anode lead 127) that extend from or are exposed to the outside of the case 160.

FIG. 3 shows that the cathode lead 107 and the anode lead 127 protrude from an upper side of the case 160 in a planar direction, but positions of the electrode leads are not limited thereto. For example, the electrode leads may protrude from at least one of both sides of the case 160, or may protrude from a lower side of the case 160. Alternatively, the cathode lead 107 and the anode lead 127 may be formed so as to protrude from different sides of the case 160, respectively.

The lithium secondary battery may be manufactured, for example, in a cylindrical shape using a can, a prismatic shape, a pouch shape or a coin shape.

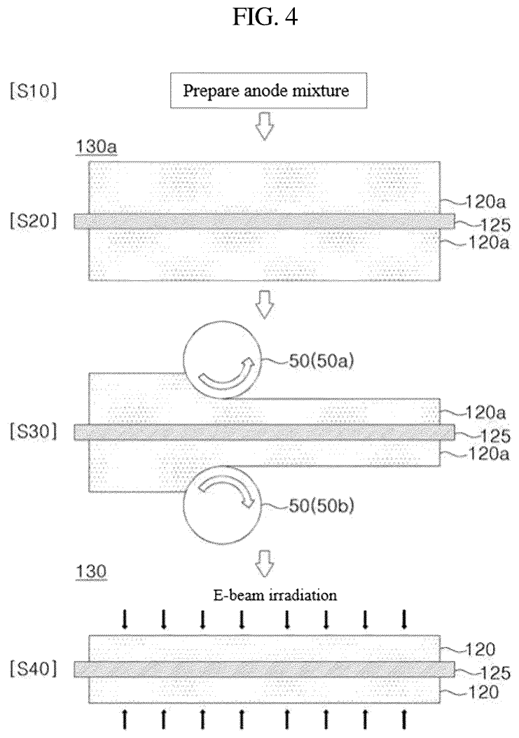

FIG. 4 is a schematic flowchart illustrating a method for manufacturing an anode for a lithium secondary battery according to exemplary embodiments. Detailed descriptions of materials/configurations substantially the same as or similar to those described with reference to FIGS. 1 to 3 are omitted.

Referring to FIG. 4, for example, in step S10, an anode mixture may be prepared. As described above, an anode active material, a first preliminary binder including an epoxy-based binder or an acrylate-based binder, and a second binder including a hydroxyl group or a carboxyl group may be mixed in a predetermined amount to prepare an anode mixture. The anode mixture may further include a conductive material, a third binder including a fluorine-based binder or a rubber-based binder, and/or a silane coupling agent.

The anode mixture may be dispersed in a solvent to prepare an anode slurry.

The solvent may be an aqueous solvent such as water, pure water, deionized water, distilled water, aqueous hydrochloric acid, or aqueous sodium hydroxide; an alcoholic solvent such as ethanol, isopropanol, methanol, acetone, n-propanol, or t-butanol; or a non-aqueous solvent such as N-methyl-2-pyrrolidone (NMP), dimethylformamide, dimethylacetamide, N,N-dimethylaminopropylamine, ethylene oxide, or tetrahydrofuran.

The content of each of the anode active material, the first preliminary binder, and the second binder may be controlled based on the total weight of the anode mixture or the anode active material layer.

For example, the solvent included in the anode slurry may be removed through a drying process, or the like. Accordingly, the content of each of the anode active material, the first preliminary binder, and the second binder may be adjusted based on the total weight of the anode mixture.

For example, in step S20, the anode slurry may be coated on the anode current collector 125 and dried to form a preliminary anode active material layer 120a. Accordingly, a preliminary anode 130a including the anode current collector 125 and the preliminary anode active material layer 120a formed on at least one surface of the anode current collector 125 may be formed.

In some embodiments, the preliminary anode active material layer 120a may be formed on both surfaces (the upper and lower surfaces) of the anode current collector 125, respectively.

For example, in step S30, the preliminary anode active material layer 120a may be roll-pressed. According to exemplary embodiments, a rolling process may be performed using a press roll 50.

For example, the preliminary anode 130a may be supplied between a first press roll 50a and a second press roll 50b disposed to face each other, so that pressure due to the rotation of the press rolls 50 may be applied to the preliminary anode active material layer 120a. Accordingly, the thickness of the preliminary anode active material layer 120a may be reduced, and the components of the anode mixture may be compressed or pre-crosslinked.

For example, in step S40, the preliminary anode active material layer 120a may be irradiated with an electron beam.

The electron beam may be irradiated onto the surface of the preliminary anode active material layer 120a, thereby activating the first preliminary binder. Accordingly, bonding between the first preliminary binders may be induced, thereby forming the above-described first binder including a polymer of an epoxy-based binder or an acrylate-based binder. For example, radical crosslinking may be induced by the electron beam irradiation.

According to exemplary embodiments, the electron beam irradiation may be performed after the rolling process. With the interaction distance between the anode active material particles (e.g., artificial graphite particles) sufficiently reduced by the rolling process and the anode mixture preliminarily compressed and crosslinked, the electron beam irradiation may perform a crosslinking action on the first preliminary binder.

According to exemplary embodiments, the electron beam may induce crosslinking between the first preliminary binder and the second binder.

For example, when the anode mixture includes the third binder, the third binder may be crosslinked with the first preliminary binder or the second binder. Accordingly, the bonding strength between the binders may be further enhanced.

For example, when the anode mixture includes the silane coupling agent, the physical bonding between the anode active material particles due to the silane coupling agent may be enhanced.

Therefore, the electron beam irradiation may sufficiently achieve a substantial adhesion strength enhancement effect. In addition, the electron beam irradiation prior to the pressing process may prevent an increase in resistance that may result from bonding between the anode active material particles or binder particles.

In the electron beam irradiation process, the electron beam irradiation conditions may be controlled.

According to exemplary embodiments, the electron beam may be irradiated under voltage conditions of 10 MeV or less.

In some embodiments, the voltage condition may be 8.0 MeV or less, 6.0 MeV or less, 5.0 MeV or less, 4.0 MeV or less, 3.5 MeV or less, 3.0 MeV or less, 2.5 MeV or less, or 2.0 MeV or less. In some embodiments, the voltage condition may be 0.01 MeV or more, 0.03 MeV or more, 0.05 MeV or more, 0.1 MeV or more, 0.15 MeV or more, 0.2 MeV or more, 0.22 MeV or more, 0.25 MeV or more, or 0.3 MeV or more.

In some embodiments, the electron beam may be irradiated under voltage conditions of 0.05 MeV to 10 MeV.

According to exemplary embodiments, the dose of the electron beam may be 300 kGy or less.

In some embodiments, the dose of the electron beam may be 290 kGy or less, 280 kGy or less, 275 kGy or less, 270 kGy or less, 265 kGy or less, 260 kGy or less, 255 kGy or less, or 250 kGy or less. In some embodiments, the dose of the electron beam may be 1 kGy or more, 2 kGy or more, 3 kGy or more, 4 kGy or more, 5 kGy or more, 6 kGy or more, 7 kGy or more, 8 kGy or more, 9 kGy or more, 10 kGy or more, 15 kGy or more, or 20 kGy or more.

In some embodiments, the dose of the electron beam may be 10 kGy to 300 kGy.

Under the above voltage conditions and dose conditions, crosslinking of the first preliminary binder may be efficiently performed. For example, if the voltage and dose exceed the above numerical range, the binder structure may change, thereby hindering lithium ion mobility. For example, if the voltage and dose are less than the above numerical range, crosslinking of the first preliminary binders may not occur, resulting in a decrease in the adhesion strength of the anode active material layer.

In some embodiments, vacuum drying may be performed after irradiating the preliminary anode active material layer 120a with an electron beam.

The anode active material layer 120 may be formed through the vacuum drying.

For example, crosslinking between preliminary binders that are not crosslinked after the electron beam irradiation may be performed through the vacuum drying. For example, crosslinking may be performed among the first preliminary binder, the second preliminary binder, and the third preliminary binder.

In some embodiments, the vacuum drying may be performed at a temperature range of 70° C. to 250° C., 75° C. to 200° C., 80° C. to 190° C., 85° C. to 180° C., 90° C. to 170° C., or 90° C. to 150° C.

Within the above temperature range, thermal crosslinking of the preliminary binders may be performed. Accordingly, the adhesion strength of the anode active material layer 120 may be further improved.

Hereinafter, experimental examples including specific examples and comparative examples are presented to aid in the understanding of the present invention. However, these examples are provided merely for illustrative purposes of the present invention and are not intended to limit the scope of the appended claims. It will be apparent to those skilled in the art that various changes and modifications can be made within the scope and spirit of the present invention, and such changes and modifications are to be regarded as falling within the scope of the appended claims.

### Example

Artificial graphite and natural graphite as carbon-based active materials, carbon black as a conductive material, poly(ethylene glycol) diglycidyl ether (PEGDE, Mn=500) as a first binder, carboxymethyl cellulose (CMC) as a second binder, and styrene-butadiene rubber (SBR) as a third binder were mixed to prepare an anode mixture in the form of a slurry.

The prepared anode mixture was applied to the upper and lower surfaces of an anode current collector (Cu foil) to a thickness of 200 μm each, and then dried at 80° C. to form a preliminary anode active material layer. The preliminary anode active material layer was pressed using a press roll to a thickness of 100 μm.

An electron beam was irradiated onto the surface of the roll-pressed preliminary anode active material layer. After further drying in a vacuum oven at 110° C. for 12 hours, an anode for a lithium secondary battery including the anode active material layer was manufactured. The electron beam was irradiated under conditions of 0.3 MeV voltage and 200 kGy dose.

### Examples and Comparative Examples

Anodes and lithium secondary batteries were manufactured in the same manner as in the above example, except that the composition of the anode active material layer was changed according to Table 1. Gamma-glycidoxypropyltrimethoxysilane was used as the silane coupling agent in Table 1. In Examples 11 and 12, poly(ethylene glycol) diacrylate (PEGDA, Mn=500) was used as the first binder instead of PEGDE.

TABLE 1

| | Content (wt %) | | | | | | |
|---|---|---|---|---|---|---|---|
| | Carbon-based active | | | | | | |
| | material | | | | | | Silane |
| | Artificial | Natural | Conductive | First | Second | Third | coupling |
| Classification | graphite | graphite | Additive | binder | binder | binder | agent |
| Example 1 | 70 | 26 | 0.5 | 0.2 | 1.3 | 2.0 | — |
| Example 2 | 70 | 26 | 0.5 | 0.9 | 0.6 | 2.0 | — |
| Example 3 | 70 | 26 | 0.5 | 0.2 | 1.6 | 1.7 | — |
| Example 4 | 70 | 26 | 0.5 | 0.9 | 0.3 | 2.3 | — |
| Example 5 | 70 | 26 | 0.5 | 0.9 | 1.3 | 1.3 | — |
| Example 6 | 70 | 26 | 0.5 | 0.1 | 0.7 | 2.7 | — |
| Example 7 | 70 | 26 | 0.5 | 0.9 | 1.6 | 1.0 | — |
| Example 8 | 70 | 26 | 0.5 | 0.1 | 0.5 | 2.9 | — |
| Example 9 | 70 | 26 | 0.5 | 0.2 | 1.3 | 1.9 | 0.1 |
| Example 10 | 70 | 26 | 0.5 | 0.2 | 1.0 | 1.5 | 0.8 |
| Example 11 | 70 | 26 | 0.5 | 0.2 | 1.3 | 2.0 | — |
| Example 12 | 70 | 26 | 0.5 | 0.9 | 0.6 | 2.0 | — |
| Comparative | 70 | 26 | 0.5 | 0.0 | 1.5 | 2.0 | — |
| Example 1 | | | | | | | |
| Comparative | 70 | 26 | 0.5 | 1.2 | 1.0 | 1.3 | — |
| Example 2 | | | | | | | |

Additionally, anodes and lithium secondary batteries were manufactured in the same manner as in Example 1, except that the voltage and dose conditions for the electron beam irradiation were changed as shown in Table 2 below. In Comparative Example 3, an anode and a lithium secondary battery were manufactured in the same manner as in Example 1, except that the preliminary anode active material layer was not irradiated with an electron beam.

TABLE 2

| Classification | Voltage (MeV) | Dose (kGy) |
|---|---|---|
| Example 13 | 1.5 | 200 |
| Example 14 | 6.0 | 200 |
| Example 15 | 11.0 | 200 |
| Example 16 | 0.04 | 200 |
| Example 17 | 0.3 | 50 |
| Example 18 | 0.3 | 250 |
| Example 19 | 0.3 | 400 |
| Example 20 | 0.3 | 5 |
| Comparative Example 3 | — | — |

### Experimental Example

### (1) Evaluation of Adhesion Strength

The adhesion strength of the anode active material layers manufactured according to the examples and comparative examples was measured using a Surface and Interfacial Cutting Analysis System (SAICAS).

Specifically, a DN-20 (DAIPLA Corporation) was used as the SAICAS instrument, and a Borazon cutter blade having a thickness of 1.0 mm (rake angle: 20°; clearance angle: 10°) was inserted into the anode active material layer to a depth of 15 μm from the surface. The force required to scrape the anode active material layer was then measured under conditions of a horizontal speed of 5 μm/sec and a vertical speed of 0.5 μm/sec.

### (2) Evaluation of Interface Resistance

The interface resistance of the anodes of the examples and comparative examples was measured using an XF057 instrument (Hioki Co.) under conditions of a measurement current of 10 mA and a measurement voltage of 0.5 V.

TABLE 3

| | Adhesion | Interface |
|---|---|---|
| Classification | strength (kN/m) | resistance (Ω · cm²) |
| Example 1 | 0.15 | 0.04 |
| Example 2 | 0.22 | 0.05 |
| Example 3 | 0.13 | 0.05 |
| Example 4 | 0.12 | 0.04 |
| Example 5 | 0.21 | 0.09 |
| Example 6 | 0.08 | 0.04 |
| Example 7 | 0.25 | 0.10 |
| Example 8 | 0.08 | 0.04 |
| Example 9 | 0.21 | 0.05 |
| Example 10 | 0.27 | 0.12 |
| Example 11 | 0.17 | 0.05 |
| Example 12 | 0.22 | 0.06 |
| Example 13 | 0.18 | 0.05 |
| Example 14 | 0.20 | 0.06 |
| Example 15 | 0.21 | 0.12 |
| Example 16 | 0.07 | 0.04 |
| Example 17 | 0.20 | 0.04 |
| Example 18 | 0.24 | 0.05 |
| Example 19 | 0.25 | 0.12 |
| Example 20 | 0.07 | 0.04 |
| Comparative Example 1 | 0.05 | 0.05 |
| Comparative Example 2 | 0.32 | 0.11 |
| Comparative Example 3 | 0.05 | 0.04 |

As shown in Table 3, in the examples including the first binder and the second binder, where the first binder content was 0.1 wt % to 1 wt % based on the total weight of the anode active material layer, the adhesion strength of the anode active material layer was improved without increasing the interface resistance of the anode.

In Example 5, where the sum of the contents of the first and second binders was relatively increased, the anode resistance increased. In Example 6, where the sum of the contents of the first and second binders was relatively decreased, the adhesion strength of the anode active material layer decreased.

In Example 7, where the sum of the contents of the first and second binders relatively increased and the content of the third binder relatively decreased, the resistance of the anode increased. In Example 8, where the sum of the contents of the first and second binders relatively decreased and the content of the third binder relatively increased, the adhesion strength of the anode active material layer decreased.

In Example 10, where the content of the silane coupling agent was relatively high, the anode resistance increased.

In Example 15, where the electron beam irradiation voltage was increased, the anode resistance increased. In Example 16, where the electron beam irradiation voltage was decreased, the adhesion strength of the anode decreased.

In Example 19, where the electron beam irradiation dose was increased, the anode resistance increased. In Example 20, where the electron beam irradiation dose was decreased, the adhesion strength of the anode decreased.

In Comparative Example 1, where the first binder was not included, the adhesion strength of the anode active material layer was significantly reduced.

In Comparative Example 2, where the content of the first binder exceeded 1 wt % based on the total weight of the anode active material layer, the interface resistance of the anode was significantly increased.

In Comparative Example 3, where the electron beam irradiation was not performed, the adhesion strength of the anode active material layer was significantly reduced.

### DESCRIPTION OF REFERENCE NUMERALS

50: Press roll
50a: First press roll
50b: Second press roll
100: Cathode
105: Cathode current collector
110: Cathode active material layer
120: Anode active material layer
120a: Preliminary anode active material layer
125: Anode current collector
130: Anode
130a: Preliminary anode
140: Separation membrane
160: Case

What is claimed is:

1. An anode active material layer for a lithium secondary battery, comprising:
an anode active material;
a first binder comprising a polymer of an epoxy-based binder or an acrylate-based binder, and
a second binder comprising a binder including a hydroxyl group or a carboxyl group,
wherein the content of the first binder is 0.1% by weight to 1% by weight based on the total weight of the anode active material layer.

2. The anode active material layer for a lithium secondary battery according to claim 1, wherein the content of the second binder is 0.3% by weight to 1.7% by weight based on the total weight of the anode active material layer.

3. The anode active material layer for a lithium secondary battery according to claim 1, wherein the sum of the contents of the first and second binders is 1.0% by weight to 2.0% by weight based on the total weight of the anode active material layer.

4. The anode active material layer for a lithium secondary battery according to claim 1, further comprising a third binder including a fluorine-based binder or a rubber-based binder.

5. The anode active material layer for a lithium secondary battery according to claim 1, wherein the epoxy-based binder includes epoxy groups at both ends and ethylene glycol repeating units.

6. The anode active material layer for a lithium secondary battery according to claim 1, wherein the acrylate-based binder includes acrylate groups at both ends and ethylene glycol repeating units.

7. The anode active material layer for a lithium secondary battery according to claim 1, wherein the second binder includes a cellulose-based binder.

8. The anode active material layer for a lithium secondary battery according to claim 1, wherein the adhesion strength is 0.05 kN/m to 0.30 kN/m.

9. An anode for a lithium secondary battery, comprising:
an anode current collector, and
the anode active material layer according to claim 1 disposed on at least one surface of the anode current collector.

10. A lithium secondary battery, comprising:
the anode for a lithium secondary battery according to claim 9; and
a cathode disposed opposite to the anode for the lithium secondary battery.

11. A method for manufacturing an anode for a lithium secondary battery, the method comprising:
preparing an anode slurry including an anode active material, a first preliminary binder including an epoxy-based binder or an acrylate-based binder, and a second binder including a hydroxyl group or a carboxyl group;
applying the anode slurry to an anode current collector to form a preliminary anode active material layer, and
irradiating the preliminary anode active material layer with an electron beam to form an anode active material layer.

12. The method according to claim 11, wherein in the step of irradiating the preliminary anode active material layer with an electron beam to form the anode active material layer, a first binder including a polymer of the epoxy-based binder or the acrylate-based binder is formed from the first preliminary binder.

13. The method according to claim 12, wherein the content of the first binder is 0.1% by weight to 1% by weight based on the total weight of the anode active material layer.

14. The method according to claim 11, wherein the electron beam is irradiated under a voltage condition of 0.05 MeV to 10 MeV.

15. The method according to claim 11, wherein the dose of the electron beam is 10 kGy to 300 kGy.
